(19) United States
(12) Patent Application Publication
(10) Pub. No.: US 2019/0136899 A1
(43) Pub. Date: May 9, 2019

(54) NICKEL PLATED CONNECTOR ENGAGING NUTS

(71) Applicant: GlobalTech Subsea, Inc., Houston, TX (US)

(72) Inventors: Blake Costanzi, Houston, TX (US); Ben Donnell, Missouri City, TX (US)

(73) Assignee: GlobalTech Subsea, Inc., Houston, TX (US)

(21) Appl. No.: 16/184,148

(22) Filed: Nov. 8, 2018

Related U.S. Application Data
(60) Provisional application No. 62/583,145, filed on Nov. 8, 2017.

(51) Int. Cl. F16B 33/00; F16B 37/00

(52) U.S. Cl. CPC F16B 33/008; E21B 41/0007; F16B 37/00

(57) ABSTRACT

A plated fastener for use in marine environments is provided, the fastener including at least a composite metal base member including one or more of nickel, bronze and aluminum, wherein the composite metal base member further includes at least an engagement nut manufactured to mate with an associated flanged connector receptacle having one or more of a 4-pin, 6-pin and 8-pin connector; and a coating layer including at least nickel, wherein the coating layer inhibits electrolysis and corrosion and pitting of the composite metal base member is avoided.

### STATEMENT OF RELATED APPLICATIONS

The instant U.S. non-provisional application claims the benefit of prior U.S. provisional application No. 62/583,145 filed Nov. 8, 2017, the entirety of which is commonly owned and hereby incorporated by reference.

### FIELD OF THE INVENTION

The present invention relates generally to fasteners for connectors on blow out preventers and other oilfield service equipment, and in a specific though non-limiting embodiment to connector engaging nuts manufactured from composite metals that have additionally been plated by nickel so as to retard electrolysis and prevent premature pitting and corrosion of the connectors.

### BACKGROUND

Pressure balanced oil filled (PBOF) cables are employed in marine-based rig environments, and are typically disposed near the ocean floor. The connectors interface with multiple one-atmospheric and other pressure compensated vessels housing electrical interfaces disposed between a plurality of electronic controls and a plurality of sensors. The assembly is designed to supply power and communication links between a multiplex subsea control system's various points of distribution (“MUX PODs”).

Design of the cable assembly and associated interface to the one-atmospheric housing is very important, as a faulty assembly can render a MUX POD or sensor inoperable and cause downtime attributable to troubleshooting the fault or defect and/or replacing or maintaining any deleteriously affected parts or systems. Even a single day of such downtime can cost an operator hundreds of thousands or even millions of dollars per day.

As seen in FIGS. 1a and 1b, for example, connectors failing due to a poor selection of material composition can suffer pitting and corrosion attributable to electrolysis, which is essentially the breaking down of a compound containing ions into its constituent elements.

There is therefore, a longstanding but unmet need for connector engaging nuts that resist pitting and corrosion attributable to electrolysis, which can be safely, reliably and cost effectively manufactured and employed in marine environments.

### SUMMARY

A plated fastener for use in marine environments is provided, the fastener including at least a composite metal base member including one or more of nickel, bronze and aluminum; and a coating layer further including nickel, wherein the coating layer inhibits electrolysis and corrosion and pitting of the composite metal base member is avoided.

### BRIEF DESCRIPTION OF THE DRAWINGS

FIGS. 1a and 1b show examples from the prior art of ineffective plating, wherein engaging nuts have become corroded and rendered useless by electrolysis and corrosion.

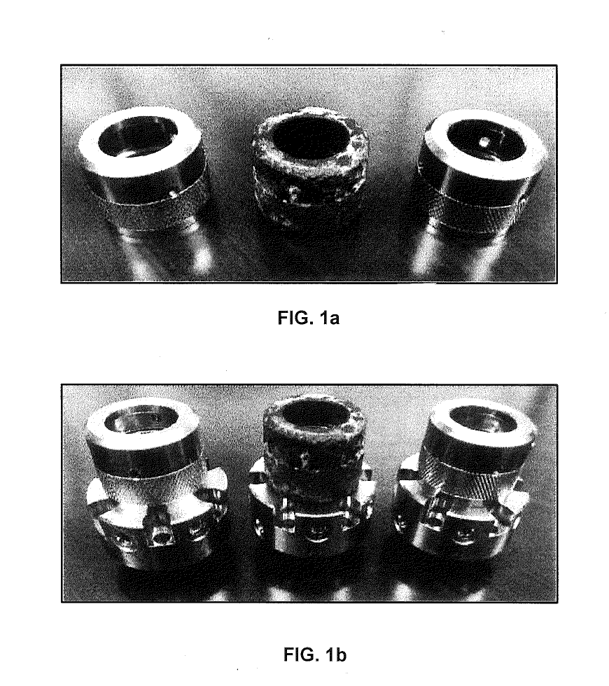

FIG. 2 shows an example engagement nut according to the invention, wherein the physical composition of the nut is coordinated with an additional layer of nickel plating such that electrolysis and corrosion do not occur.

### BRIEF DESCRIPTION OF SEVERAL EXAMPLE EMBODIMENTS

As one of ordinary skill in the pertinent arts will readily appreciate, PBOF cable assemblies generally terminate with reciprocally mated engaging nuts that connect the cable to a flanged connector receptacle (FCR) affixed to the MUX POD.

Current industry standards dictate that the constituent metals employed in fabrication of such connectors comprise nickel, bronze and/or aluminum, as such compositions all bond well with a stainless steel FCR, though other compositions and other, similar compositions comprising different ratios of the same metals are also known.

However, as ordinarily skilled artisans will also appreciate, such compositions are highly susceptible to electrolysis as negatively charged ions migrate toward positively charged electrodes and positively charged ions migrate toward negatively charged electrodes. As the process progresses, electrically neutral atoms and molecules are formed that are then released from their attractive binding, and pitting and corrosion occur as the compound breaks down.

The present invention overcomes this longstanding problem by fabricating an underlying base connector out of one or more of nickel, bronze and/or aluminum, and then sealing the composite connector in a nickel plated coating that greatly resists electrolysis because nickel alone, as with most metals, contains only positively charged ions and therefore does not break down like the underlying composite metal alloys. In short, a fastener is achieved that is electrochemically inert (or as nearly so as possible) and pitting and corrosion typically associated with such processes are avoided.

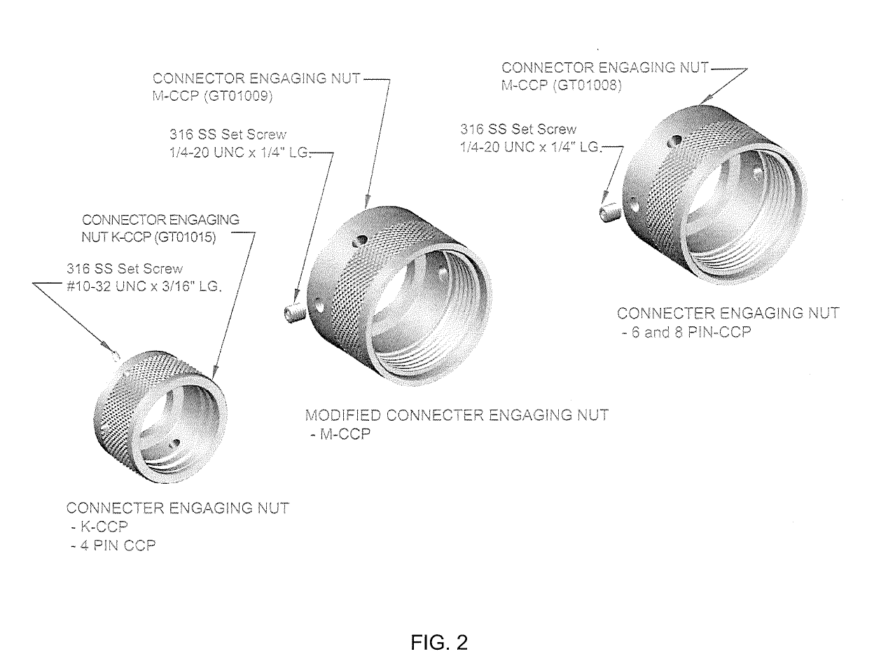

As seen in FIG. 2, the principle of operation holds regardless of size and volume; for example, 4-pin, 6-pin and 8-ping connectors can all be coated with electrolysis resistant nickel with equal efficacy, so long as the specific plating and underlying composite metals are considered so that the fastener as a whole become electrochemically inert or nearly so, and electrolysis and corrosion are avoided.

In an associated method of practicing original installation, maintenance or replacement of such connectors, the instant inventors have determined that the following detailed, though non-limiting method is especially effective.

First, a purchase order is sent to an appropriate manufacturing vendor; for example, an engaging nut purchase order can be sent to the vendor together with engineering drawings and any other special instructions relevant to the transaction. When the purchase order is received, a predefined inspection procedure is carried out to ensure that all parts ordered and manufactured are actually present in the shipment and have been manufactured to the defined specifications. Assuming so, the parts are then received into inventory.

The parts are then shipped to an appropriate plating vendor. In one example, embodiment, the engaging nut is boxed and shipped to the vendor in a manner ensuring the nut is not nicked or scratched or otherwise damaged during transit. For example, the nuts can be wrapped in foam sheets or the like to prevent damage. In a further embodiment, the wrapped nuts are sent to the vendor together with a purchase order for the desired plating services.

Finally, after plating and the return of the engaging nuts back from the plating vendor, the quantity of the shipment, quality of the plating, and a physical damage inspection are carried out and verified. Afterward, the newly plated connectors are received back into inventory.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from either the spirit or scope thereof.

1. A plated fastener for use in marine environments, said fastener comprising:
a composite metal base member comprising one or more of nickel, bronze and aluminum; and
a coating layer further comprising nickel,
wherein said coating layer inhibits electrolysis and corrosion and pitting of the composite metal base member is avoided.

2. The plated fastener of claim 1, wherein said composite metal base member further comprises an engagement nut.

3. The plated fastener of claim 2, wherein said engagement nut is manufactured so as to mate with an associated connector receptacle.

4. The plated fastener of claim 3, wherein said engagement nut is manufactured so as to mate with an associated flanged connector receptacle.

5. The plated fastener of claim 3, wherein said associated connector receptacle further comprises a 4-pin connector.

6. The plated fastener of claim 3, wherein said associated connector receptacle further comprises a 6-pin connector.

7. The plated fastener of claim 3, wherein said associated connector receptacle further comprises an 8-pin connector.

8. The plated fastener of claim 3, wherein said associated connector receptacle further comprises a connector having more than 8-pins.

9. The plated fastener of claim 1, wherein said coating layer further comprises another metal in additional to nickel.

10. The plated fastener of claim 1, said fastener comprising:
a composite metal base member comprising one or more of nickel, bronze and aluminum, wherein said composite metal base member further comprises an engagement nut manufactured to mate with an associated flanged connector receptacle comprising one or more of a 4-pin, 6-pin and 8-pin connector; and
a coating layer further comprising nickel,
wherein said coating layer inhibits electrolysis and corrosion and pitting of the composite metal base member is avoided.
